(19) United States
(12) Patent Application Publication
(10) Pub. No.: US 2018/0089748 A1
(43) Pub. Date: Mar. 29, 2018

(54) Personalized Environments

(71) Applicants: A Ray Chaudhuri, San Rafael, CA (US); Dean Nakamura, Montgomery Village, MD (US)

(72) Inventors: A Ray Chaudhuri, San Rafael, CA (US); Dean Nakamura, Montgomery Village, MD (US)

(21) Appl. No.: 15/576,614

(22) PCT Filed: May 22, 2016
(86) PCT No.: PCT/US16/33687

§ 371 Date: Nov. 22, 2017

Related U.S. Application Data
(60) Provisional application No. 62/165,625, filed on May 22, 2015.

(51) Int. Cl. G06Q 30/06

(52) U.S. Cl. CPC G06Q 30/0639; G06Q 30/0641

(57) ABSTRACT

The subject matter relates to a system which provides personalized information to an individual relating to, for example, food choices, recreational options, health care options and so on, when the individual is away from home.

### FIELD

The subject matter of interest relates to materials and methods associated with computer programs and display devices to assist individuals in locating services, consumables, commodities, products and the like that are local to a remote site where the user is located, which may be a predetermined locale, location or site, geographic or otherwise, for example, when a user is not at home, by accessing a hosting computer or server comprising said computer programs and a data base comprising location-specific information, and optionally, to arrange implementation or delivery of a product or service to a designated site, such as, a business, temporary abode; to make a purchase; to place a reservation; and so on. A customer or user inputs personal data, such as, health information and consumer behavior information, which is compiled, manipulated, analyzed and correlated by a hosting computer to identify a subset of services, consumables, products, events and the like from a library of data comprising a listing of purveyors of property or services, events and the like, local to the site remote from home where the user is present, personalized and unique to the individual based on and correlated with the personal data inputted by the individual. The personalized set of information information can be displayed on any device, such as, in a facsimile, a telephone, such as, a cellular telephone or a smart telephone, a portable electronic device, a computer and so on to enable communication with the hosting computer or server and optionally with computer systems of a service or product provider. The products and services of the user when at home comprise a first environment, and the products and services of the user when away from home comprise a second environment. The microenvironment established by the correlated information, which can include, for example, health and lifestyle activities, dietary choices or restrictions and the like, can provide personalized activities, services, providers and the like, for and of the individual, customer or user, that are familiar and desired by the individual, for example, when away from home.

### BACKGROUND

Portable and/or mobile computing devices are known, many of which integrate a wireless means of communication when access to information not stored in those devices is needed. Thus, laptop computers, personal digital assistants (PDA), handheld computers, tablet computers, telephones, such as, mobile or smart telephones, facsimile devices and the like are available commercially. Vendors offer different operating systems for use in those devices, such as, Android, OS X, iOS, Windows Phone, Windows 10 Mobile, webOS, QNX and so on. Aside from general functions, such as, data processing, word processing, executing telephone communications, web browsing or searching the internet, and so on, programs or subroutines operable in such operating systems are known, which provide for a variety of other functions on such portable and/or mobile devices, such as, games, cameras, for example, for photographs or recording videos, and so on. Some of those programs, particularly those usable on a telephone are known commonly as, “phone apps.”

A number of programs executable on mobile telephones are known, many of which are not developed or created by the phone manufacturers, owners or developers. Thus, it is known to third parties how to write programs, code, that can be downloaded, read and executed by operating systems of mobile and/or portable devices. For example, U.S. Pat. Nos. 7,936,284, 8,271,057, 8,577,803, 8,612,136, 9,064,259, 9,105,046, 9,235,717, 9,244,522, 9,268,829, 9,270,758, 9,325,683, 9,338,650, 9,313,162, 9,344,994, 9,323,643 and so on, all incorporated herein by reference in entirety, teach various aspects of the phone app art, including programs operable on telephones.

An example of a remote user assessing a data base is provided in U.S. Pat. No. 8,060,383 where food bar codes and nutrition labels are scanned and that information about a product is routed to a program, that might contain additional information on that product, but also contains dietary information of a user. A program compares features of a product being considered for purchase or for ingestion by a user with stored dietary parameters of that individual to determine if a food contains any allergens or other ingredients that could be or are harmful to that individual.

Another example of an accessible data base is one for making restaurant reservations. A user accesses a database where restaurants are categorized by city or local region. A user then can locate a suitable restaurant, date and time for dining, and can make a reservation, see U.S. Pat. Nos. 8,856,117, 9,189,551 and 9,195,769, each incorporated by reference herein in entirety.

An individual often settles into or develops a routine set of day-to-day activities, such as, food choices, timing of dining, clothing, exercise activities, timing of exercise activities, other physical activities, entertainment types and choices, social activities, personal activities, health considerations and so on. The routine may be dependent on individual preferences or other conditions, for example, health conditions which command certain particularized choices. It may not be uncommon for an individual to employ a portable device or a phone app to search the web or to contribute to, to exploit or to practice that routine.

There is a need or an advantage for a tool that provides an individual with information and options to replicate substantially that routine set of day-to-day activities when away from home. Hence, a personalized set of information relating to, for example, grocery sources, food choices, service sources, healthy living options, such as, exercise options, such as, a gym, a yoga studio and so on, certain food options, such as, vegan grocers and restaurants, and so on, a timetable, appointments, dining selections, exercise options, social activities and so on provides an individual with conditions that would simulate that routine lifestyle and the components thereof away from home as experienced when at home. The individual inputs parameters and data framing the interests and needs of the individual, which then are correlated with products, events and services local to a preselected site or a site when the user is away from home and local to that remote site to provide a recognizable microenvironment or second environment for the individual no matter the location of the individual.

### SUMMARY

The subject matter of interest relates to an integrated solution to assist an individual in identifying, locating and acquiring a desired set of products, events, services and the like to provide an individual with an environment of desired conditions that simulate the normal routine and environment of that individual when at home, when that user is away or remote from home. An executable program comprising a database or library comprising information of elements that comprise an environment, such as, vendors, products, events, services and the like, which are categorized or indexed to particular geographic sites, such as, districts, neighborhoods, cities, regions, states, countries and the like, along with other descriptors or identifiers, and information in that library is correlated with data inputted by an individual and personalized to that individual to identify a subset of information that correlates with the data input to simulate the environment of the home of the user with or in a second environment at a site remote from the user home. That subset of correlating information comprises, for example, offerors, service providers, events, products, services and so on that correlate with the input data, which correlated data provide conditions for a second environment of and for the individual at the remote site that simulates the environment of the user when at home. Desired personal or social events, opportunities and the like can be provided for meetings, social events, social interactions, recreational activities and the like.

That subset of information parsed in a host computer can be transmitted to a device in communication therewith, such as, a display device, such as, a personal digital assistant, a computer, a laptop, a tablet, a telephone, such as, a mobile or smart phone, an enabled watch, enabled glasses and so on, that enables a user to view desired information regarding a particular product, event or service, as provided herein, and to store that selected subset of personalized information for later use, updating, supplementing and so on. A display device is in communication with a data base or library of information contained or stored in a data storage device and a data processing device of interest, such as, a server or a computer, identified herein as a host computer, for example, by a wireless means, to enable a user to access and to exploit a central, base or general database of a host computer. A user is provided details of a product, event or service of interest, location of said product, event or service in a building, site, location of product or service offering and the like local to a remote suite or a second environment of user. Information of a product and/or service along with location thereof also can be provided. In embodiments, an integrated application optionally schedules appointments or meetings, makes reservations and the like for a consumer; providing a calendar, schedule, timetable and the like to guide the hourly and daily activities of an individual and so on when that user is away from home.

In embodiments, individual input data can be stored for subsequent use. Users can have multiple or plural files relating to different or plural environments. User input data can be altered, updated, entries can be removed and so on at any time after opening an account. In embodiments, individual input data can be shared by servers at different locales. Such an architecture enables storage of subset(s) of information local to the various servers, which may provide for enhanced processing of information by, for example, reducing the amount of stored and indexed data in each of plural servers. In embodiments, an individual is enabled to alter the correlated data set so that one or more options identified by the processing unit of the host computer or server from the library of data, can be deleted as undesired by the individual to provide a further amended subset of information pared or modified to those of particular interest to the individual, which can include data and information regarding a product, a distributor, a purveyor and so on. That data then is stored as a personalized set of information of that user for that environment.

Selected or permitted (for example, by a user) information (portions of which may be coded, encrypted or redacted so as not to reveal certain information, such as, a user, to third parties) and data, optionally, can be used by producers, distributors, providers, offerors, service providers, sellers and the like to monitor consumer use; to assess marketing information; to contemplate consumer opinions regarding products or services; to address individual opinions, complaints or criticisms that can improve the offering of said service or product; and so on.

In embodiments, a user may annotate or include further data regarding the retrieved data to provide personal information about a product or service advanced by the program of interest for future personal reference.

In embodiments, a listing of correlated or filtered information is communicated to a provider who fulfills a desired product, a purchase, a service and so on, for example, by providing an item of a correlated individual list by accessing an account of the individual or user, such as, a reserve or escrow account or credit/debit card information, to settle the cost of the item or service on the list; and delivers the item or service on the list to the user or to a site accessible by the individual.

In embodiments, the database can be used to provide a user, consumer or individual with information of a particular application of interest. Hence, for example, if a user has particular dietary needs or a dietary interest, or certain health conditions, such as, a cardiac problem, a diabetes, and so on, a query can be transmitted to the central database of the host computer to access information of what products or services correlate with and to the area of interest defined by the inputted data, are available. The products can be purchased on line or in person. Similarly, a dietary need may comprise certain health requirements, such as, periods of physical activity or exercise, or foods to eat or to avoid. Those requirements can be fulfilled by providing the individual with a list of services or service providers, such as, local gyms or spas, jogging routes, yoga studios, restaurants, grocers and the like. The health needs can include a list of local doctors, physicians, clinics, hospital and health care providers that are versed to address any specific needs of the individual. Appointments can be made and directions to the site provided to the individual.

As mentioned herein, some user preferences or conditions may relate to one or more personal, dietary, health or other parameters of the user or individual. In the context of physical or health parameters, a user can include information that impacts whether a product of service can be practiced; the nature of service that can be practiced; the nature, type or amount of a food or drink; and so on. The consumer data and health data may be made available (optionally with approval of the user) to producers, providers, purveyors, offerors and the like to ensure awareness of and compliance with the parameters; or as a reference, in the event a user exhibits symptoms requiring medical intervention or treatment, and that health data contributes to the user medical history to guide appropriate treatment.

The program and data are configured to be provided in a format compatible with various devices available to users to facilitate user use of the program of interest. Data can be stored in more than one language, for example, to be compatible with different operating systems, different word processing programs and so on. That enables access to the program of interest, sharing of portions of or of permitted data, sharing of non-personal or permitted user data, sharing of marketing information and so on with other third party programs. For example, individualized monitoring of health conditions, using, for example, dedicated portable, point-of-use devices, is known, see, for example, U.S. Pat. Nos. 8,684,922 and 8,583,402. The instant program can be configured to interface with such programs so accumulated or permitted data obtained from such devices can be incorporated into the data base of interest.

Various other embodiments, embellishments and variations of the above are provided in the non-limiting description and figures following.

### BRIEF DESCRIPTION OF THE DRAWINGS

The following drawings described herein are non-limiting examples that depict various embodiments that exemplify the present subject matter of interest.

FIG. 1 is a branching diagram depicting an aspect of the subject matter of interest showing a theoretical set of input and output actions of data and information, indicated as circles or ovals containing an identifier within. The set of input and output actions presented in FIG. 1 is representative and is not to be considered limiting in any way. Similarly, the paths of information or action flow as depicted by unidirectional arrows are illustrative only. Paths in any direction can be developed between or among any two or more input or output actions. A computer program of a host computer governs data storage as a library, compares functions and data, analyzes functions correlating individual input data with information in a library of interest; and displays functions and data, providing an individual with a subset of correlated data and information obtained from the library which are particularized to the individual and data inputted thereby for and to comprise a second environment. The information of FIG. 1 depicts an embodiment of the invention, use of a search paradigm to provide personalized information to a hotel guest who can simulate out of town, away from home, remote from home and so on, an environment that is the same as or resembles the normal, day-to-day routine and environment of the hotel guest when the guest is at home. Hence, a guest can input data (through, for example, “Account Setup/Health History,”) into a hosting computer comprising a library of, “Information,” of products, events and services (for example, circles identified as, “Guest,” “Information,” “Account Setup,” and, “App Integration,” for example.) A user can interface with a host computer using, for example, “Wearables,” which can be digital devices that are worn by a user, such as, a watch or other device that is clipped on, pasted, pinned, worn and so on to or on a user which is enabled to communicate with a host computer. A host computer can interact with other programs or data bases, for example, to extract and down load additional information for a user profile or file, (“App Integration.”) A host computer stores user information. The stored user information (“Personal Profile/Private,”) can be summarized to provide a report, including, for example, correlations or recommendations of a diet or exercise regimen (“Reports Diet/Exercise.”) A user can enable access of such information to a professional, an advisor and so on (“Health Coach.”) When queried as to a search function, a program parses a library of information in the context of user information to select those items which are correlated in the two lists to produce a subset of information personalized to an individual at or relating to a site remote from home (such as, “Hotel,”), and the resulting list can provide to a guest, a user and so on, suggestions, appointments and the like, those outputs identified in the circles denoted as, for example, “Exercise,” “Gyms/Fitness Facilities,” “Diet/Menu,” “ “Medical Spa,” “Restaurants,” “Rx/Clinic/Hospitals,” and, “Grocery.”

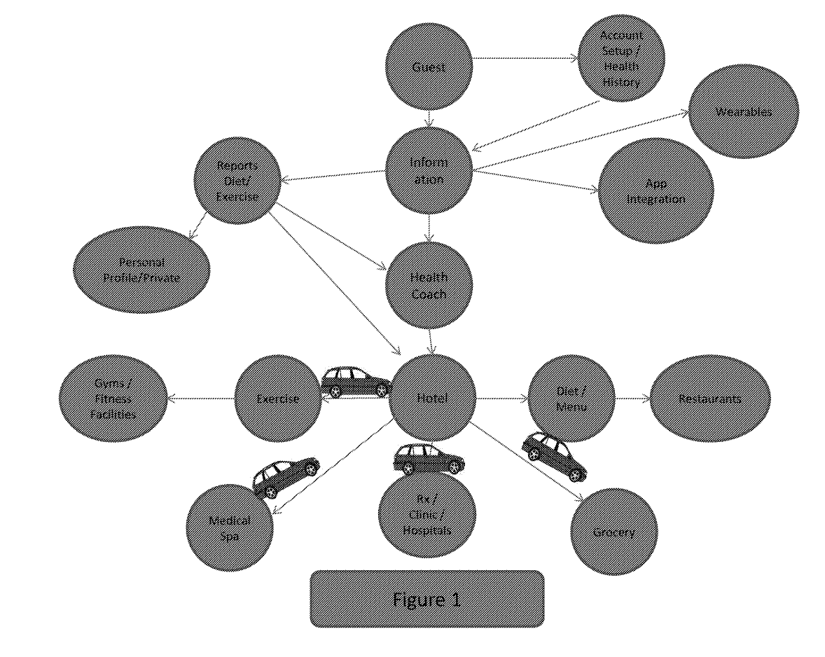

FIG. 2 is a branching diagram depicting an aspect of the subject matter of interest, aside from merely correlating or matching in a more computational maneuver, based on, for example, information in the public domain, showing a theoretical set of input (“Health History,” “Action,” and “Comments,) and output (“Goal Set/Commitments,” “1^{st} Appointment,” “Outcome/Next Apt,” “Continue Cycle,” “Completed results,” and, “Not completed,”) actions of data and information, indicated as circles or ovals containing an identifier within. The set of input and output actions presented in FIG. 2 is representative and is not to be considered limiting in any way. Similarly, the paths of information or action flow as depicted by unidirectional arrows are illustrative only. Paths in any directions can be developed between or among any two or more input or output actions, as governed by a program of a host computer governing data storage and analysis of a library, comparing functions, analyzing functions correlating the individual input data with information in a library and display functions, providing an individual with a subset of correlated data obtained from a library particularized to an individual and data inputted thereby. The information of FIG. 2 depicts an embodiment of the invention, use of a search paradigm to provide personalized information to an individual relating to health issues, for example, to provide automated health tracking. Hence, an individual can input data into a hosting computer comprising a library of information of products, events and services (circles identified as, “Health History,” and,” “Account Setup,” for example) relating to health issues and a hosting computer, once that inputted information is analyzed and used to parse a library of information therein for those items that correlate to the inputted data that comprise a subset of information personalized to an individual, can provide that information to the individual as suggestions, appointments and the like, those outputs identified in the circles denoted as, for example, “Goals,” “1^{st} Appointment,” and, “Outcome.”

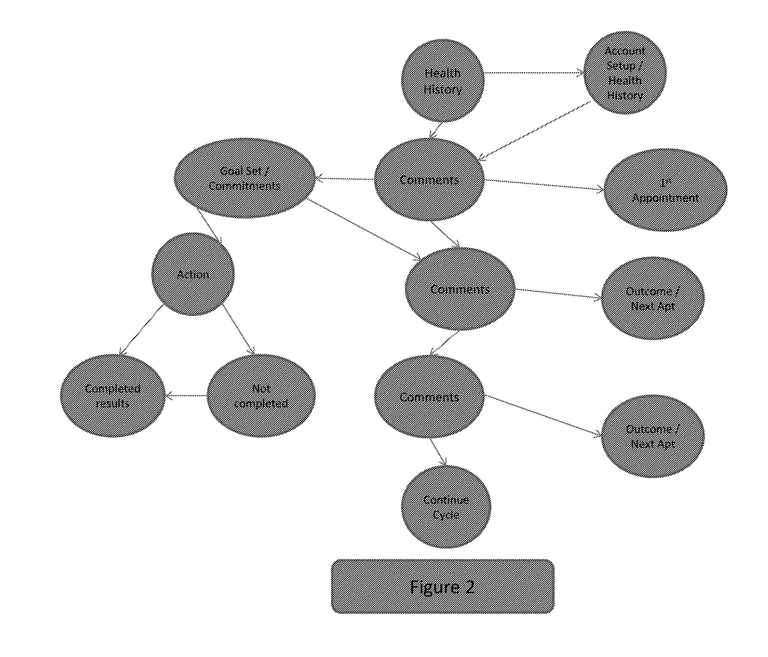

### DETAILED DESCRIPTION

The subject matter of interest relates to one or a plurality of hosting computers or servers (optionally, in communication therebetween or thereamong), each comprising a data base or library, which may be unique to a locale on one of a plurality of servers, and a data processing device, which compares, filters or correlates information of a library comprising services, events, products, providers and the like to a particular set of search parameters of an individual, including a site parameter, such as, a geographic parameter, to provide a site-specific subset of services, events, products, providers and the like for use by a user at a particular site. The data may be centralized at a single site, for example, in a server, or may be segmented at plural physical sites, but which can be accessed by a control or common data processing device and program, or the plural servers can comprise portions of a data base, where a portion can relate to a various or particular region or site, thereby separating a data base into plural data bases of smaller size. A plurality of remote devices can be in communication with that control data base of a host computer, for example, by a wireless communication device and means, such as, a laptop, a tablet or a telephone.

The total data base, or if separated, the region-specific or locale-specific data base is mined for a subset of information of particular products, events, services and providers using data inputted by and for an individual, which subset of information is used by and for an individual. In embodiments, a returned subset of data provides options that enable a microenvironment of an individual that simulates the day-to-day activities of the individual, for example, when an individual is removed from or not at home, for example, on vacation or on a business trip.

In embodiments, the subject matter of interest can be employed as a customer relationship management system where a provider can offer a customized set of events, activities, services, goods and the like that are particularized and desired by an individual, which customized set of data can be altered over time to include new businesses and to delete those no longer available or of interest.

By, “product,” is meant any physical structure, article or substance, or an item that is produced, such as, a code, or a program that can be utilized by an individual.

By, “service,” is meant any offering that is not a product. A service can include expertise, work, activity, advice, assistance, supply, exchange, opportunity to exploit, such as, a swimming pool, a gym, a spa, a clinic, a hospital, a social setting or establishment, a personal interaction and so on, and the like, where a third party executes, or makes available or provides an opportunity for the benefit of user.

By, “individual,” is meant a customer, user, person and equivalent, anyone who can access and does access a host computer to obtain personalized information therefrom. The terms are used interchangeably herein.

By, “host computer,” is meant the device that stores, processes and analyzes the library of information based on the search parameters provided by an individual. The information comprises searchable terms, descriptors, properties and the like of a datum or data entry in the library. Such information includes the name of the datum per se, along with annotations or metadata of the datum.

By, “home,” is meant a residence or abode of a user, the physical address and structure where a user normally resides. Often, home comprises an environment in which the user is most habituated. However, for the purposes herein, a home serves only as a frame of reference to comprise a first environment.

By, “remote,” is meant a locale, site, place and the like, geographic or otherwise, not closely situated or not located near home, that is, away from home. A user may be remote or away from home when, for example, at work, on vacation, on holiday, at a time share, on a day trip away from home and so on. Hence, remote comprises a second environment different the environment of home of the user. A user can have more than one second environment.

By, “hotel,” is meant collectively, any residence of time shorter than residence at home, and can include, for example, a hotel, a motel, a boat, a train, a bed and breakfast, a hostel, a timeshare, a vehicle, a rented or leased condominium, a town house, a house or portion thereof, such as, a room, such as, a bread and breakfast, or that offered by various websites, such as, airbnb, VRBO and so on, and so on.

By, “house,” is meant, collectively, a house, a unit in a condominium, a townhouse, a unit in an apartment, a unit in a hotel, a unit in a motel and so on.

By, environment,” is meant features, aspects, attributes, products, activities and the like of a user. Elements of an environment include and relate to products, people, services and the like, favored and/or used by a user. Thus, a home of a user comprises an environment and includes, for example, parks, grocery stores, theaters, drug stores, parks, restaurants, gas stations, physician(s), dentist(s) and so on. When user is remote from home, and far enough away, all of those elements in the home environment will no longer be local to user. Hence, user generates using a program of interest, a second environment of that remote site containing some or all of those elements which are or may be used or accessed by user at the remote site. Because of the local nature of products and services, a user likely will have a plurality of environments for each of the locales frequented or used by user. A second environment can be the same as, resemble or be different from a first environment. A user can have any number of environments.

By, “integrated application,” is meant a coordinated system providing a subset of personalized information to an individual. Hence, an integrated application includes, for example, a host computer, a remote device in data communication with a host computer and so on. An integrated application also is referred to herein as a, “system.” Data communication, or input/output communication, can be of any means, such as, hardwire, wireless and so on.

By, “module,” or, “circuity,” equivalent phrases and terms, and grammatic variations thereof is meant a code, a program, an algorithm, a logic, a decision tree, a flow chart and the like that comprises a coordinated and sequential set of commands and actions for interpretation and implementation by a processor to provide a comparing or filtering function of interest to provide a site-specific subset of a data base comprising an environment for a site remote from home. A module can comprise hardware, such as, a circuit, a semiconductor, a chip and so on comprising a physical structure that comprises and enables operation of a set of instructions or a program.

The term, “circuit,” may mean, among other things, a single component or a multiplicity of components (whether in integrated circuit form or otherwise), which are active and/or passive, and which are coupled together to provide or to perform a desired function. The term, “circuitry,” may mean, among other things, a circuit (whether integrated or otherwise), a group of such circuits, one or more processors, one or more state machines, one or more processors implementing software, one or more gate arrays, programmable gate arrays and/or field programmable gate arrays, or a combination of one or more circuits (whether integrated or otherwise), one or more state machines, one or more processors, one or more processors implementing software, one or more gate arrays, programmable gate arrays and/or field programmable gate arrays. The term, “datum or data,” may mean, among other things, a current or voltage signal(s) whether in an analog or a digital form, which may be a single bit (or the like) or multiple bits (or the like).

Circuits and circuitry may be described using computer aided design tools and expressed or represented, as data and/or instructions embodied in a known computer-readable medium, for example, in terms of, for example, a logic component, a transistor, a layout geometry and so on. Formats of files in which such circuit expressions may be implemented include, but are not limited to, C, Verilog, HLDL, RTL, GDSII, CIF, MEBES and so on, without limitation. Compatibility with user devices and operating systems and word processing language therein can drive selection of suitable language or languages for program files of interest. A computer-readable medium includes, but is not limited to, a non-volatile storage medium, such as, an optical, magnetic or semiconductor storage medium, and carrier waves that may be used to transfer such formatted data and/or instructions through wireless, optical or wired signaling media or any combination thereof. Examples of transfers of such formatted data and/or instructions by carrier waves include, but are not limited to, transfers over the internet, but can be over a local network as well.

Hardware can include processing circuitry, a user interface, input/output circuitry transmitter circuitry and the like.

The term, “calculate,” “compare,” “filter,” “process,” and the like, and forms thereof means, among other things, to calculate, to assess, to compare, to file, to determine, to process and so on where user parameters are matched to a data base to retrieve those datum elements that correlate with the user parameters in the form of a subset of location-specific data. “Correlate,” is a synonymous term and relates to a process of comparing personal options, selections, parameters, choices, characteristics and so on which set of information of a user is compared to location-specific information of a basic or general data base to select those data points of the general data base that are for a particular locale and which are similar to, are associated with and so on to information of the user. The degree of association can be variable and a design choice, and quantifiable, for example, as a sliding scale percentage of similarity where 100% is considered identity or a perfect match and values lower than 100% are less than perfect matches of varying confidence of similarity. Choices of interest to and of a user can be stored in a host computer or on a user device as a location-specific subset of information relating to products, services and the like favored by the individual at a particular remote environment away from home, comprising a second environment.

By, “library,” is meant a data base of information that comprises various elements comprising a universe of environments, and when indexed relating to a particular site, locale or location, is specific to a locale. A library is analogous to, for example, a telephone book or an event calendar. A library can be updated as needed. A library can comprise all data or a library can be partitioned to contain categories of data, wherein the categories represent, for example, nested groups of data or mutually exclusive groups of data. For example, using as a parsing criterion, geographic locale, and the United States as the area covered by data of a library of interest as an example, a library can be partitioned into a plurality of data sets that comprise information from individual states, from US Census Bureau division of the United States, data sets that comprise information from Northeastern States, from Midwestern States, from Western States and from Southern States, or a data set for Northeastern States can be parsed into data sets for New England States and for Mid-Atlantic States, a data set for Western States can be parsed into data sets for Mountain States and for Pacific States and so on. Each of the component data sets can be contained in a different server.

The present invention can be implemented in hardware, software, firmware or a combination thereof. In embodiments, the invention is implemented with a computer program or programs that operate computer and communications equipment. Computers, operating systems, data processing systems and the like are known and are not limited for practice of the subject matter of interest.

An exemplary computer and communications equipment may include one or more host computers, data processing device or devices and devices that access the host computers via a communications device. Equipment illustrated and described herein are examples of equipment that may be used to implement embodiments of the invention and may be replaced with other computer equipment without departing from the scope of the invention.

The host computer(s) serve as a repository of data to implement aspects of the present invention as described herein. A host computer may be any computing device, such as, a network or server computer and may be connected to a firewall to prevent tampering with information stored on or accessible by computers to provide security of individual inputted data, such as, HIPAA compliance. Functionality of a host computer also may be distributed amongst different computers in a cloud computing environment. One host computer may be a device that operates or hosts a website accessible by at least some of the devices, for example, for an individual to input personal data. Hence, a host computer can include conventional web hosting operating software, an internet connection, such as, a cable connection, satellite connection, DSL converter or ISDN converter, and is assigned a URL and corresponding domain name so that the website can be accessed via the internet in a conventional manner. In embodiments, a host computer can comprise a plurality of computers, each which accesses a central data base or each with a portion of total data.

A host computer may host and support software and services of mobile devices that enable data input and output, and data display, such as, Google, Toshiba, Sony, Samsung, Apple and Blackberry. For example, a host computer may support Google Android mobile applications and another host computer may support Apple iPhone mobile applications.

Computer and communications equipment also may include or use a data interchange format device for distinguishing types of devices (e.g. mobile phone, desktop computer) that attempt to access host computers and for routing communications and requests to host computers accordingly.

Electronic devices, such as, a telephone, such as, a mobile phone, a smart phone, a satellite phone and so on, a portable digital assistant, a tablet, a watch, a portable device worn by a user and so on may be used by an individual wishing to view, to receive and/or to provide information described herein. The electronic devices may be any type of device that can access a host computer via a communications network. Each electronic device can include or can access a web browser, a cellular or mobile telephone network and a conventional internet connection, such as, a wireless broadband connection, a modem, DSL converter, ISDN converter and the like that enables access to the internet.

Electronic devices may include, for example, one or more mobile communication devices, such as, phones, personal digital assistants (PDA's) manufactured by or for, for example, Samsung, Google, Apple or Blackberry, MP3 devices, laptops, tablets, computers, handheld game players or any other data communication device. Any of a number of or form of devices may access a host computer.

A communications network can be the internet but may be any other communications network, such as, a local area network, a wide area network, a wireless network or an intranet. A communications network also may be a combination of several forms of network. For example, electronic devices wirelessly may communicate with a computer or hub in a store via a WiFi network, which in turn, is in communication with one or more host computers via the internet or other communication network. Other wireless means include ANT, a WPAN, WLAN, Bluetooth, Zigbee and so on, the goal being to access a host computer, which may be located remotely or distally from a user not at home. In the case of the former, connection can be through the internet while in the latter, for example, a host computer may be located in a hotel where a user is staying, a proximal wireless means or a hardware connection can be used. Thus, in embodiments, a user device is connected directly with a host computer, for example, using an Ethernet connection.

The computer program of the present invention is stored in or on a computer-readable medium residing on or accessible by a computer and communications equipment, such as, a host computer, or a centralized computer to which a plurality of host computers communicate. The computer programs can comprise ordered listings of executable instructions for implementing logical functions in the host computers and/or devices. The computer programs can be embodied in any computer-readable medium for use by or in connection with an instruction execution system, apparatus or device, such as, a computer-based system, processor-containing system or other system that can fetch the instructions from the instruction execution system, apparatus or device, and execute the instructions, that is accepting individual input data, storing said data, comparing said data with a library for correlations and providing said correlations to an individual. In embodiments, a host computer interfaces with a business to make an appointment or to make a purchase on behalf of an individual.

In context of the instant application, a, “computer-readable medium,” can be any means that can contain, store, communicate, propagate or transport a program for use by or in connection with an instruction execution system, apparatus, or device. A computer-readable medium can be, for example, but not limited to, an electronic, magnetic, optical, electromagnetic, infrared or semi-conductor system, apparatus, device or propagation medium. Although not inclusive, examples of a computer-readable medium include an electrical connection having one or more wires, a portable computer diskette, a random access memory (RAM), a read-only memory (ROM), an erasable, programmable, read-only memory (EPROM or flash memory), an optical fiber and a portable compact disk read-only memory (CDROM).

A host computer comprises or has access to a library of information, which is classified to be unique for a locale that contains accessible information relating to products, events and services provided in that locale. Hence, accessible and searchable information relating to merchants, events, products, service providers and the like for a plurality of environments are provided in a library. Thus, data are provided and stored in a format that is searchable in a host computer. Data may be coded and/or categorized to facilitate orderly storage and ready searchable access.

By, “local,” is meant, located within 1 mile, within 2 miles, within 3 miles, within 4 miles, within 5 miles or more of a site at which a user is located, which is remote from home. Local can be defined by an individual as a search parameter of distance from a predetermined site as a design choice. A host computer data base can extend to including contact information with purveyors of products and services, and can act on contact information on behalf of an individual.

In embodiments, an integrated application of interest can provide functions to attract or to entice a user to view a particular product, service or provider. For example, through an integrated application, a user can be provided with promotions and invitations to special events, access product availability, access a store locator, be provided with opportunities to pre-order and to reserve items, and so on. Displayed functions also can be selected based on user preferences or history of product or service use.

In embodiments, an integrated application can provide enhanced item information to a user. For example, a user may scan an advertisement including a barcode, embedded pixel pattern or other information-including and decodable pattern with an electronic device. By doing so, a user can access enhanced information associated with an item of an advertisement. As another example, social networking features can be provided by allowing a user to create wish lists, look books, gift guides or other collections of items. Those collections then may be provided to a social website or otherwise shared such that friends or acquaintances can provide feedback.

Examples of retrieved information from a correlation have been mentioned herein and include, spas, gyms, groceries, martial arts studios, restaurants, transportation means, such as, taxis and limousines, pharmacies, clinics, hospitals, health care professionals, clothing, walking or jogging paths, dentists, medical and dental specialists, social activities, personal meetings and so on.

In embodiments, an integrated application can provide a user with sales assistance (e.g., while a user is in a store or with a provider). For example, items in a store may include an optical pattern (e.g., a barcode) on an item. A user then may scan the optical pattern to obtain additional information or features associated with that item. For example, the optical pattern may be scanned by taking a digital image of a price tag with a camera of an electronic device of the user. By analyzing an optical pattern of a digital image, an integrated application of interest may access information associated with the item, such as, ratings, availability (e.g., in a particular size, color, style or the like), comparisons (e.g., price comparisons of the same or similar items from other providers or other store locations), recommendations, ingredients and other suitable features.

In embodiments, an integrated application can provide an individual with up-selling and cross-selling opportunities. For example, an integrated application may access a database of items currently owned by a user. Based on that database, the integrated application may locate items available for purchase from one or more providers that can be matched with the currently owned inventory of items of a user.

In embodiments, an integrated application can provide a user with post-purchase opportunities. For example, a user can be provided with opportunities to rate and to review a store, a provider, an item or any combination of the above, which review can be downloaded to a hosting computer. As another example, an interface can be provided allowing a user to mix-and-match currently purchased items to build a composition of interest, such as, a home structure, a food or other consumable and so on. Thus, using historical data to identify buying trends of a particular user, providers can deliver personalized notifications directly to an electronic device of a user.

An illustrative electronic device for providing an application operative to interface with a provider system in accordance with some embodiments of the invention can be any device that accesses and communicates with a host computer. Electronic device can include control circuitry, storage, memory, input/output (“I/O”) circuitry and communications circuitry. In embodiments, one or more components of an electronic device can be combined or omitted (e.g., storage and memory may be combined). In embodiments, an electronic device can include other components, e.g., motion detection components, a power supply, such as, a battery or kinetics, a display, bus, a positioning system, a camera, an input mechanism, etc.)

Electronic device can include any suitable type of electronic device. For example, electronic device can include a portable electronic device that a user may hold in his or her hand, such as, a digital media player (e.g., an iPod, iPad or iPhone, Apple Inc., Cupertino, Calif.), a consumer electronic device (e.g. Nexus, Google), a personal e-mail device (e.g., a Blackberry, RIM, Waterloo, Calif.), a personal data assistant (“PDA”), a cellular telephone, a handheld gaming device, a digital camera and so on. As another example, electronic device can include a larger portable electronic device, such as, a tablet or a laptop computer. As yet another example, electronic device can include a substantially fixed electronic device, such as a desktop computer.

Control circuitry can include any processing circuitry or processor operative to control operations and performance of an electronic device. For example, control circuitry can be used to run operating system applications, firmware applications, media playback applications, media editing applications or any other application. In embodiments, control circuitry can drive a display and process inputs received from a user interface.

Storage can include, for example, one or more storage media including a hard-drive, solid state drive, flash memory, permanent memory, such as, a ROM, any other suitable type of storage component, or any combination thereof. Storage can store, for example, media data (e.g., music and video files), application data (e.g., for implementing functions on electronic device), firmware, user preference information data (e.g., media playback preferences), authentication information (e.g. libraries of data associated with authorized users), lifestyle information data (e.g., food preferences), exercise information data (e.g., information obtained by exercise monitoring equipment), transaction information data (e.g., information such as credit card information), wireless connection information data (e.g., information that can enable electronic device to establish a wireless connection), subscription information data (e.g., information that keeps track of podcasts, TV shows or other media a user subscribes to), contact information data (e.g., telephone numbers and email addresses), calendar information data, any other suitable data or any combination thereof.

Memory can include cache memory, semi-permanent memory, such as, RAM, and/or one or more different types of memory used for temporarily storing data. In embodiments, memory also can be used for storing data used to operate electronic device applications, or any other type of data that can be stored in storage. In embodiments, memory and storage can be combined as a single storage medium.

I/O circuitry can be operative to convert (and encode/decode, if necessary) analog signals and other signals into digital data. In embodiments, I/O circuitry also can convert digital data into any other type of signal, and vice-versa. For example, I/O circuitry can receive and convert physical contact inputs (e.g., from a multi-touch screen), physical movements (e.g., from a mouse or sensor), analog audio signals (e.g., from a microphone) or any other input. Digital data can be provided to and received from control circuitry, storage, memory or any other component of an electronic device.

An electronic device can include any suitable interface or component for allowing a user to provide inputs to I/O circuitry. For example, electronic device can include any suitable input mechanism, such as, a button, keypad, dial, a click wheel, a touch screen and so on. In embodiments, electronic device can include a capacitive sensing mechanism, a multi-touch capacitive sensing mechanism and so on.

In embodiments, electronic device can include specialized output circuitry associated with output devices, such as, for example, one or more audio outputs. An audio output can include one or more speakers (e.g., mono or stereo speakers) built into an electronic device, or an audio component that is coupled remotely to an electronic device (e.g., a headset, headphones or earbuds that can be coupled to a communications device with a wire or wirelessly).

In embodiments, I/O circuitry can include display circuitry (e.g., a screen or projection system) for providing a display visible to a user. For example, a display circuitry can include a screen (e.g., an LCD screen) that is incorporated in an electronics device. As another example, a display circuitry can include a movable display or a projecting system for providing a display of content on a surface remote from an electronic device (e.g., a video projector). In embodiments, a display circuitry can include a coder/decoder (CODEC) to convert digital media data into analog signals. For example, a display circuitry (or other appropriate circuitry within electronic device) can include video CODEC's, audio CODEC's or any other suitable type of CODEC.

A display circuitry also can include display driver circuitry, circuitry for driving display drivers or both. A display circuitry can be operative to display content (e.g., media playback information, application screens for applications implemented on an electronic device, information regarding ongoing communications operations, information regarding incoming communications requests, or device operation screens) under direction of control circuitry. Alternatively, a display circuitry can be operative to provide instructions to a remote display.

Communications circuitry can include any suitable communications circuitry operative to connect to a communications network and to transmit communications (e.g., voice or data) from electronic device to other devices within a communications network. Communications circuitry can be operative to interface with the communications network using any suitable communications protocol such as, for example, Wi-Fi (e.g., a 802.11 protocol), Bluetooth, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

In embodiments, communications circuitry can be operative to create a communication network using any suitable communications protocol. For example, communications circuitry can create a short-range communications network using a short-range communications protocol to connect to other devices. For example, communications circuitry can be operative to create a local communications network using a Bluetooth protocol to couple electronic device with a Bluetooth headset.

An electronic device can include one more instances of communications circuitry for simultaneously performing several communications operations using different communications networks. For example, an electronic device can include a first instance of communications circuitry for communicating over a cellular network and a second instance of communications circuitry for communicating over Wi-Fi or using Bluetooth. In embodiments, the same instance of communications circuitry can be operative to provide communications over several communications networks.

In embodiments, an electronic device can be coupled to a host device for data transfer, synching the communications device, software or firmware updates, providing performance information to a remote source (e.g., providing riding characteristics to a remove server) or performing any other suitable operation that can require electronic device to be coupled to a host device. Several electronic devices can be coupled to a single host device using a host device as a server.

An electronic device, such as, a portable computer, can access a host computer, for example, via the internet, and a user then may view pages on a host computer website. In embodiments, for greater interactive ability, an electronic device may use a word processing program, a graphic program and so on. In embodiments, for greater interactive ability, a host computer may make available to transfer and to download onto a remote electronic device, a program or subroutine that enables an electronic device, and hence, a user, to interact with a data base and programs of a host computer. Such a download also may endow an electronic device with active links, connections, internet access and the like with any purveyor of a product or service, or of an event of interest in which a user will engage. In embodiments, a download of executable functions from a host computer can be identified as a telephone application.

In embodiments, an electronic device may include an integrated application operative to interface with a provider system to provide access to different items and services made available by a provider. As used herein, the term, “provider,” can refer to a merchant, a shop (e.g., a physical store, an on-line store or both), or to any other entity suitable for providing items to a user. The items can include, for example, clothing (e.g., shirts, pants, jackets, socks or other clothing), accessories (e.g., watches, hats, purses, jewelry or other accessories), footwear or other suitable items that a person may wear or carry; a food or drink; hardware; furniture and the like, as well as services.

A user interfaces with a host computer by any means so enabled. Thus, for example, a user can employ any device that can process a set of executable commands that enable communication with and input of data to and subsequently a data stream comprising a subset of personalized information from a comparing program of interest. A program of interest provides a questionnaire, set of queries and the like that reflect parameters that will shape, define, describe, comprise and the like elements that comprise a second environment that is locale-specific and different from the home environment of user. The questions or queries can be presented in the form of multiple choice questions or queries for ease of digitizing user data. User answers those questions or queries of interest to provide a profile or to define parameters and elements that comprise a user environment remote from user home. Those answers are stored on a host computer in a user file. The logic, program, subroutine and the like of interest acquires and stores data relating to parameters and elements as defined by answers to the questions and queries targeted at acquiring such information specific to a user and to a site. User information is stored, for example, in a storage module which is accessible by a program of interest. When a command to correlate user parameters with data of a particular locale of a general data base is placed by a user, that command is executed by a program of interest. Correlations, that is, entries of a data base of interest that have a relationship, are similar to, have a commonality with, correlate with and so on with a user answer or answers are tagged and included in a result list that will comprise elements of a remote user environment, and that subset of data is provided as a second environment to the user.

A data base of interest comprises information of products, services and the like which comprise a plurality of environments. Each data point or datum of a library comprises a product or service and a geographic location associated therewith (for example, as comprising metadata of that product or service) as well as one or more descriptors, adjectives, review classification, tags and the like that provide a characterization of that data point or entry, which geographic location and one or more descriptors contribute to or comprise a searchable element or elements of that datum, which in turn, relates to a product or service, stored in a data base. The descriptive and annotative aspects of a data entry can comprise searchable descriptive or guide metadata associated with a datum of a library of interest.

A natural language processing scheme also can be used to obtain or to derive descriptors of a product or service and to provide a searchable data base using enable search parameters of a user.

The various data points are classified, compartmentalized, indexed, hierarchically organized and so on to provide readily searchable data points for comparison to and with a user query. How data points are indexed, classified and so on in a searchable data base is a design choice. A user search query can access physical information of a product or service, such as, name, address, proprietor, reviews and so on, as well as the descriptors and the like associated with a product or a service. Each data point is tagged with a description of a location or address. Indexing of data provides for categorization, headings, ready access to data, ready access to data of a particular type, such as, a dentist, or a particular domain or locale, such as, Honolulu, and so on.

Because a focus of the invention of interest is geographic, a device comprising a computer program of interest can interface with a navigation system and program that provides information of geographic location and thus, can provide information on location of a device comprising a navigating program and device, to and for a program of interest. That information can be used by a program of interest to frame and to select a particular classified set of information relating to a particular location where a mobile device of interest is located. For example, if a user travels outside of the US to Canada, for example, to Toronto, a locating program, such as, a GPS-based program, can locate a mobile computing device of a user as being in Toronto, and based on that information, a program of interest can apply that locating information to select data associated with Toronto for viewing by the user or for further parsing based on user input.

Results of a search query yield a subset of information obtained from a database that comprises data points that correlate with parameters associated with a geographic location and with a user. A program can have a degree of correlation between a user parameter and a searchable and correlated feature of a data point that can vary as a design choice or can be a preselected choice to control the number of matches, the quality of matches (that is, the degree of similarity, correlation, association and so on, using, for example, a statistic treatment for determining correlation) or both. The degree of correlation can be determined using a statistical method to provide, for example, a numerical degree of correlation, such as, a percent value, where 100% can be taken to indicate the matched data point correlates well with a search parameter.

An obtained subset of information comprising a remote environment of a user can be saved. Alternatively, each subset can be deleted, for example, following a defined, finite period of time, and a new query conducted, for example, because a data base is updated with new data points, whether new products or services, or new or different descriptors associated with a product of service are introduced into a database, or data points are removed because a product or service becomes obsolete or is not desired.

Any source of information can be used to populate a database of interest. Data of various products, services and the like can be classified and entered into a data base. Data of various products, services and the like can be introduced by a user in an exercise of crowdsourcing. That data can be classified and entered into a data base. Data can be obtained from another third party data base.

The invention creates a unique and dynamic user experience, such as, away from home. For example, an integrated application can create an experience that is personal and connected to a user (e.g., by promoting continuity and maintaining contact between a provider and a user based on user personal preferences and habits). An integrated application also may enhance a user experience through monetization. For example, up-selling and cross-selling offers may be presented to a user through an integrated application. An integrated application also may allow for customer retention. For example, an integrated application can build customer relations and promote customer retention (e.g., by addressing shopper needs 24 hours a day and 7 days a week to provide utmost satisfaction). Yet another advantage of an integrated application of interest can include affiliate opportunities. Affiliate companies then may be given opportunity to reach the wider range of shoppers through an integrated application or program of interest. In that manner, a single, integrated application can control and enhance user experiences with correlated data obtained from a library.

To interface with a provider, an integrated application can use any suitable approach. In embodiments, an electronic device can connect securely to one or more servers associated with a provider (e.g., through communication circuitry). For example, an integrated application of interest can connect to servers available from one or more stores of providers to receive data reflecting items provided thereby. The received data can include information such as, for example, item size, item color, item price, availability of an item or any other suitable information. As another example, an integrated application can connect to servers to receive recommendations from providers regarding recommended combinations of items. In embodiments, an integrated application of interest can allow a user to connect to a provider server through a secure connection to perform transactions (e.g., using a credit card to consummate a purchase). In that manner, a user may, for example, pay for or reserve a particular product or service of a provider.

In embodiments, an integrated application of an electronic device can receive information from providers including metadata associated with items. Metadata can define, for example, attributes of items, such as, type of item (e.g., pants, shirt, jacket, hat and the like), color, collection, style (e.g., casual, work attire, winter clothing, summer clothing and the like), price, availability (e.g., number available at a certain store in a certain size, color, style or the like), or any other suitable characteristic of items. In embodiments, in addition to or instead of receiving metadata, an integrated application can identify attributes of merchandise from available images and descriptions of merchandise. For example, an image of an item can be taken with a camera of an electronic device. The integrated application then may analyze the image to identify attributes of that item.

The invention contemplates a plurality of host computers, which may be connected to a central data storage and processing device, each host computer comprising a locale-specific library or database to provide information on products and services of that locale tailored to an individual. Thus, for example, a hotel chain with multiple units in a city and around the country, can have inputted data from a frequent traveler and can provide that traveler with information on products and services of interest to that individual particularized and optimized for each locale, whether within a city or near a city, town, neighborhood or other geographic description or an area.

A program in a host computer comprises, for example, a questionnaire or a series of queries that is completed by an individual. A questionnaire or query tool comprises a series of questions that probe characteristics of and wants and needs of an individual. Those parameters can comprise search parameters used to probe products, events and services in a library that could be offered to an individual in a manner personalized to that individual.

Hence, for example, a questionnaire can inquire of dietary needs or physical or health restrictions of an individual, such as, food allergies, cuisine choices, diet demand, height, weight, a physical limitation, such as, a missing limb or requiring a wheel chair, and the like. If an individual provides answers to those queries that indicate a special product and/or service is needed, such as, an allergen-free food, that condition is introduced as a condition or element which serves as a search phrase, parameter or word to fine tune a search query and to ensure correlations of library elements with particular dietary needs of an individual.

In embodiments, questions may focus on health issues, for example, any physical maladies, food allergies as noted above, possible cardiac issues, blood pressure, resting pulse, resting respiration rate, blood chemistry values, aspects of a medical history and the like. Any wellness or health related issues that could be considered to be health-related, for example, as defined to be governed by HIPAA law, would be dealt with in a HIPAA compliant manner. Health conditions also can be used to define search of a library to ensure the correlated services, events and/or products consider health issues of an individual. Thus, for example, in the context of a food allergy, restaurants that are cognizant of food allergies and have menu items that would be acceptable to an individual with that allergy would comprise a correlated subset of information obtained from a library. Health issues also would trigger information on ambulances, hospitals and clinics, for example, should an individual inadvertently ingest an allergen and require medical care. That information would comprise hospital or clinic location, ambulance services, other transportation means, such as, taxis, health care providers that specialize in immunology and so on.

Also which can be included in a query tool are questions regarding particular entertainment interests so that an individual can be notified of any local events, can be notified of local establishments that might satisfy leisure or entertainment interests of an individual and so on. Such can include events in the arts, sports and so on. A user can use a program of interest to locate providers of a social nature, such as, a date or an escort, and so on.

As mentioned hereinabove, a query also can include interests of an individual as to physical or healthy activities, such as, walks, jogs, yoga, runs, sports and so on. Correlated data can provide an individual with location of local parks, pathways, tennis courts, basketball courts, lakes, rivers, ponds, bicycle rentals, local sports clubs, local gyms and the like where an individual can exercise.

Hence, once a query tool is completed, which information of an individual is dynamic and is alterable, a search function of a program of interest compares and identifies those products and services of a particular environment unique to parameters determined by an individual. That correlated information can be packaged and made available to an individual by any device that is in data communication with a host computer, such as, a laptop, a tablet, a telephone and so on. How retrieved information is provided is a design choice. For example, a list of possible restaurants can be provided. An individual can rely on a program of interest to execute other functions aside from data storage and comparison, such as, executing a particular action or accessing a website or program, device and the like that allows execution of that function, such as, to make a reservation at a particular restaurant for an individual. A diagram of running or jogging routes can be provided, using, for example, digital maps in the public domain. Names of health care providers with contact information can be provided.

Retrieved information also can include those products and services available at a remote site, for example, a hotel. Hence, various amenities provided by or at a hotel that are suitable for an individual can be provided to that individual and employees at those amenities are alerted to any specific needs of that individual. Any reservations that might be needed can be made on behalf of the individual by a program of interest or by employees at the remote site.

As provided hereinabove, services provided by the subject matter of interest can extend beyond search of a library and providing a listing of correlated products and services. Offering of services by the subject matter of interest can extend beyond a defined time frame or defined locale. Hence, for example, while a library is locale-specific, services provided by the subject matter of interest can extend beyond length of stay at a remote site and beyond locale of that remote site, optionally at request of the individual. For example, a product or service of a second environment, unbeknownst to user, is available at the home or first environment as well, for example, at a chain restaurant or store. Hence, the product or service provider of the second environment can so notify the product of service provider of the first environment.

It will be appreciated that various of the above-disclosed and other features and functions, or alternatives thereof, may be combined into many other different systems or applications. Also various presently unforeseen or unanticipated alternatives, modifications, variations or improvements may be made subsequently by those skilled in the art without departing from the scope and spirit of the subject matter of interest.

All references cited herein, are incorporated herein in entirety by reference, in entirety. Also, references cited in references cited herein are incorporated by reference herein in entirety, that is, a US patent cited in a US patent cited herein also is incorporated entirely herein by reference. For example, U.S. Pat. No. 8,577,803 cited hereinabove, cites U.S. Pat. No. 8,423,462. Thus, U.S. Pat. No. 8,423,462 is incorporated herein by reference in entirety as well.

1. A method comprising:
a) entering personal data, comprising a health or a diet product or service, of a user into an accessible user file of a host data computing device;
b) said host data computing device correlating said personal data with a library of information, comprising health or diet products or services, to provide a subset of personalized information, comprising a health or diet product or service, said subset comprising a first environment of interest or use of said user; and
c) providing said subset of personalized information comprising a first environment to said user,
wherein a health or a diet products or services of said first environment is remote from home of said user; wherein home comprises a second environment, comprising a health or a diet product or service of interest or use of said user; and wherein said first environment simulates said second environment.

2. The method of claim 1, wherein said host data computing device comprises a plurality of computing devices.

3. The method of claim 1, wherein said subset is displayed by a device which accesses the internet.

4. The method of claim 1, wherein said user is at a hotel.

5. The method of claim 1, wherein said user is in a city remote from home.

6. The method of claim 1, wherein said user is in a state remote from home.

7. The method of claim 1, wherein said user is in a country remote from home.

8. The method of claim 1, wherein said personal data comprises a medical health parameter of said user.

9. The method of claim 1, wherein said personal data is obtained from an interfaced data base.

10. The method of claim 1, wherein said subset is saved in said host data computing device, a user device in communication with said host data computing device or both.

11. A system comprising:
a) a host computing device comprising a program comprising a catalog of accessible data, comprising a health or diet product, a health or diet service, a person providing a health or diet product or service, or combination thereof; and
b) a user, not at home, comprising a user computing device in communication with said host computing device, said user computing device comprising a subset of said accessible data, comprising a health or a diet product or service of interest or use of said user, said subset comprising a first environment of said user;
wherein said first environment comprises a health or a diet products or services remote from home of said user; wherein home comprises a second environment, comprising a health or a diet product or service of interest or use of said user; and wherein said first environment simulates said second environment.

12. The system of claim 11, wherein said host computing device is present in a hotel.

13. The system of claim 11, wherein said user computing device accesses the internet.

14. The system of claim 11, wherein said user is at a hotel.

15. The system of claim 11, wherein said user is in a city remote from home.

16. The system of claim 11, wherein said user is in a state remote from home.

17. The system of claim 11, wherein said user is in a country remote from home.

18. The system of claim 11, wherein said subset comprises data correlated with a medical parameter of said user.

19. The system of claim 11, wherein said user computing device interfaces with a second data base.

20. The system of claim 11, wherein said subset is saved in said host computing device, a user computing device or both.
